(19) United States
(12) Patent Application Publication
(10) Pub. No.: US 2004/0266933 A1
(43) Pub. Date: Dec. 30, 2004

(54) Compositions comprising mineralized ash fillers

(75) Inventors: Michael L. Friedman, Wayne, NJ (US); Deborah L. Oberst, Malvern, PA (US)

Correspondence Address: DUANE MORRIS, LLP, IP DEPARTMENT, ONE LIBERTY PLACE, PHILADELPHIA, PA, 19103-7396, US

(73) Assignee: CertainTeed Corporation, Valley Forge, PA (US)

(21) Appl. No.: 10/607,743

(22) Filed: Jun. 27, 2003

(51) Int. Cl. C08K 3/34

(52) U.S. Cl. 524/442

(57) ABSTRACT

The invention relates to plastics that comprise a polymer resin and a mineralized (i.e., de-metallized) ash as a filler. The mineralized ash-filled plastics exhibit improved rheological and physical properties, relative to plastics made using other fillers. The plastics can contain a variety of other fillers and additives. The invention further relates to methods of making and using the plastics.

### BACKGROUND OF THE INVENTION

The invention relates generally to the field of polymers and other compositions which comprise inorganic fillers.

Filled plastics are widely used. Because fillers are usually less costly than the polymer matrices, significant savings can be achieved by substituting fillers in place of a polymer matrix. In addition to the cost savings, incorporation of mineral fillers into a plastic can significantly increase the tensile and flexural moduli of the plastic (relative to the same plastic not having the filler incorporated therein). Fillers also often enhance the stiffness and rigidity of polymers and reduce the coefficient of thermal expansion (CTE). Owing to the reduced CTE, the molten filled plastic shrinks and swells less than the corresponding non-filled plastic, and there is greater dimensional stability in molded and thermoformed plastics. Other beneficial effects attributable to incorporation of fillers into a plastic include enhanced fire resistance, surface hardness, and scratch resistance. Furthermore, incorporation of fillers having high aspect ratios (e.g., plate- or sheet-shaped filler particles can also decrease the permeability of the plastic to water, oxygen, carbon dioxide, and other liquid and gaseous fluids.

There are also tradeoffs associated with incorporating a filler into a plastic. Fillers permit one to forego use of an equivalent volume of polymer matrix. Because many mineral fillers have higher density than polymer matrices, the filled plastic will often have a greater density than the same plastic without the filler. Incorporation of a mineral filler can also require additives, such as coupling agents and stabilizers, to render the filler compatible with the polymer matrix. Addition of the filler and any other additives can add mixing and/or compounding steps to the plastic production process, owing to increased requirements for mixing of the polymer resin, for example.

Most mineral fillers increase the viscosity of molten polymer matrices, relative to the “neat” (i.e., non-filled) matrix. The increased viscosity makes the molten polymer more difficult to handle and can decrease the efficiency (in terms of energy consumption), capacity, or both, of plastic processing methods. Mineral fillers are generally more abrasive than the polymer matrix, and their abrasiveness contributes to increased wear on plastic handling and processing equipment. As a result, plastic processing equipment must either be replaced more often or be fabricated from more abrasion-resistant (and expensive) materials.

Incorporation of fillers in to a polymer matrix can adversely affect some of the physical characteristics of the resulting plastic. For example, incorporation of mineral fillers often reduces impact and crack resistance of the plastic. Thus, either a plastic with less favorable properties must be tolerated or the plastic must be supplemented with additional components, such as impact modifiers and internal lubricants, in order to alleviate the effect of filler addition.

Fillers can affect the appearance of the plastic in which they are used. When the consistency of appearance of a plastic is important in its end use (e.g., in paints and finished plastic boards), fillers must be selected so that a product of acceptable and reasonably consistent appearance can be made. However, controlling the content of a filler material such that its appearance and other qualities are consistent from batch to batch adds to the expense of the filler. As the cost of the filler increases, the cost savings realized by using the filler in place of the polymer matrix decreases.

A significant need exists for plastics filled with materials that are relatively inexpensive and exhibit little of the disadvantages of plastics filled with known materials. The present invention provides such plastics and methods of making them.

### BRIEF SUMMARY OF THE INVENTION

The invention relates to a plastic (e.g., a thermoplastic or a thermoset) that comprises a polymer admixed with a mineralized ash filler (MAF). The amount of ash incorporated into the plastic can vary, depending on the application and on which properties of the plastic are desired to be influenced by addition of the MAF thereto. The invention includes methods of enhancing plastic properties such as its tensile modulus, its stiffness, its surface hardness, its elongation at break, its impact resistance, and the viscosity and processibility of the fluid plastic. In one embodiment, the MAF is a mineralized fly ash obtained from incineration of coal. The MAF contains relatively low levels of leachable metals, and preferably comprises small, rounded or spherical particles—the smaller and rounder the better.

The plastic can also comprise additional ingredients, such as plasticizers, stabilizers, flow modifiers, lubricants, coloring agents, additional fillers, or nanofillers. A preferred class of nanofillers are nanoclays, such as montmorillonite, which have high aspect ratios and small particle sizes.

The plastics can be used in a wide variety of applications. For example, the plastics can be formed into building materials. The low leachable metal content of the plastic also makes it suitable for other applications for which plastics filled with ordinary ashes are disfavored, such as food and semiconductor packaging.

### BRIEF SUMMARY OF THE SEVERAL VIEWS OF THE DRAWINGS

FIG. 1 is a graph of melt flow curves for polypropylene homopolymer (smaller diamonds, circles, and triangles) and polypropylene copolymer (larger diamonds, circles, and triangles) at 190 degrees Celsius (diamonds), 210 degrees Celsius (circles), and 230 degrees Celsius (triangles).

FIG. 2 is a graph of melt flow curves for polypropylene homopolymer filled with 0% (i.e., neat homopolymer; circles), 20% (triangles), and 40% (diamonds) by weight of MFA, as assessed at 190 degrees Celsius.

FIG. 3 is a graph of melt flow curves for polypropylene homopolymer filled with 0% (i.e., neat homopolymer; circles), 20% (triangles), and 40% (diamonds) by weight of MFA, as assessed at 210 degrees Celsius.

FIG. 4 is a graph of melt flow curves for polypropylene homopolymer filled with 0% (i.e., neat homopolymer; circles), 20% (triangles), and 40% (diamonds) by weight of MFA, as assessed at 230 degrees Celsius.

FIG. 5 is a graph of melt flow curves for polypropylene homopolymer filled with none of MFA, calcium carbonate, and nanoclay (circles), with 40% by weight MFA (triangles), with 40% by weight calcium carbonate (squares), and/or with 7% by weight nanoclay (filled triangles and squares), as assessed at 190 degrees Celsius.

FIG. 6 is a graph of melt flow curves for polypropylene homopolymer filled with none of MFA, calcium carbonate, and nanoclay (circles), with 40% by weight MFA (triangles), with 40% by weight calcium carbonate (squares), and/or with 7% by weight nanoclay (filled triangles and squares), as assessed at 210 degrees Celsius

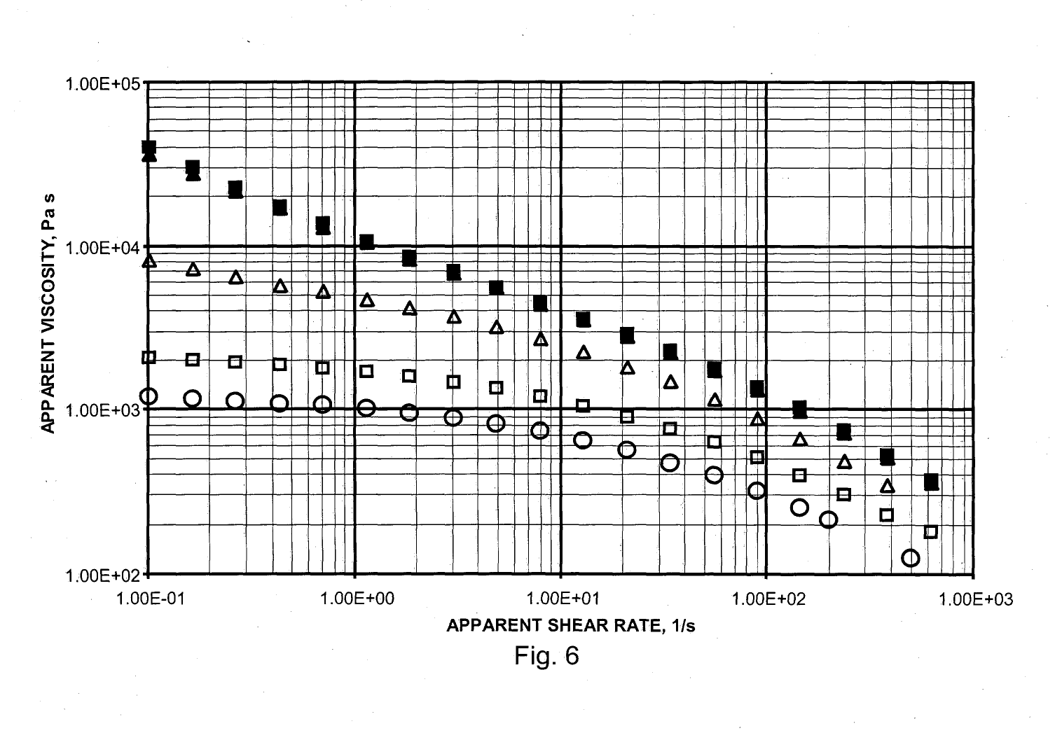

### DETAILED DESCRIPTION OF THE INVENTION

The invention relates to plastics that comprise a mineralized ash filler incorporated into the polymer matrix. Although ashes have been used as plastic fillers in the past, ash-filled plastics have exhibited properties that are unfavorable in many situations. For example, prior art ash-filled plastics exhibit impaired impact and crack resistance, compared to the corresponding neat (ash-free) polymer. Prior ash-filled plastics are also more subject to fatigue-related degradation and failure than the corresponding neat polymers. The detrimental effects of ash fillers limit their use in many plastic applications. By way of example, the increase in viscosity which ash fillers impart to plastic melts can render them unsuitable for use in high-speed process applications, where low viscosity is desirable. Further by way of example, many ash fillers contain unacceptably high levels of leachable metals and other substances which might be imparted to food or beverage products upon contact therewith, and use of such fillers in the food and beverage industries is limited.

The invention described herein relates to the discovery that “mineralization” of an ash preparation renders the ash more suitable for use as a plastic filler. Mineralization refers to removal from an ash preparation of metal atoms and compounds that are not part of a relatively inert mineral complex. Plastics that comprise a polymer matrix having mineralized ash dispersed therein exhibit properties superior to those of prior art (non-mineralized) ash-filled plastics. Surprisingly, it has also been discovered that mineralized ash fillers increase the melt viscosity far less than do other mineral fillers, such as calcium carbonate, and can decrease the melt viscosity under certain conditions.

In addition to polymers, the mineralized ash filler described herein can be used in hydraulically setting compositions, such as gypsum or cement boards, cement, concrete, asphalt, joint compound, food additives (e.g., livestock feed), and in paint and primer compositions. Use of non-mineralized ash in such products has been previously described, but use of mineralized ash has not.

Definitions

As used herein, each of the following terms has the meaning associated with it in this section.

A “plastic” is a material that i) contains as an essential ingredient an organic polymer made by covalently linking at least 100, preferably several hundred, and more preferably 1000 or more monomer segments, ii) is solid (although optionally flexible, deformable, or both) in its finished state, and iii) is fluid at some point during its manufacture (e.g., at a high temperature or prior to polymerization). The organic polymers include both compounds that are designated ‘polymers’ and compounds that are designated ‘oligomers’ (generally, relatively short polymers, comprising tens or hundreds of monomers) in the literature in this field. Polymers are characterized by the fact that the exponent in the Mark-Houwink equation is greater than 1 (usually greater than 3, such as 3.4). The Mark-Houwink equation describes the relationship between the intrinsic viscosity of a solution of a molecules comprising a chain of monomers and the molecular weight (i.e., degree of polymerization) of the molecule.

A “polymer” is an organic compound having a chemical structure that includes a chain of at least 100 monomer segments.

A “homopolymer” is a polymer in which substantially all monomers in the polymer have the same chemical structure.

A “copolymer” is a polymer comprising multiple monomer units having different chemical structures. The term “copolymer” includes copolymers of various known types, including random, block, and alternating copolymers.

A “mineralized” ash is a solid residue obtained by incineration of a substrate (e.g., coal) and subsequent removal of acid-soluble metals therefrom to yield a product comprising not more than 20% (preferably not more than 10%) of the metal content for any individual metal listed herein in Table 1 for standard fly ash, when the ash is prepared by 24-hour agitation at pH<2 in 50 milliliters per gram (of ash) reagent grade water at 95 degrees Celsius, followed by filtration over a 50-micrometer filter, and the metal content of the supernatant is analyzed by U.S. Environmental protection Agency (EPA) method 200.7 (all metals except mercury) and by EPA method 245.1 (for mercury). The EPA methods are described in Methods for the Determination of Metals in Environmental Samples—Supplement I (EPA-600/R-94-111, May 1994; NTIS publication PB 94-184942). Preferably, substantially all acid-soluble metals are removed from the incineration solids.

A “thermoplastic” polymer is one which is capable of being reversibly softened by an increase in temperature (e.g., above the melting point for crystalline polymers or above the softening temperature range for amorphous polymers) and hardened by a decrease in temperature without substantial chemical structural change. In a softened form, thermoplastic polymers can be shaped, extruded, or molded into desired configurations.

A “thermoset” polymer is a substantially insoluble polymer formed by cross-linking a precursor of the polymer by application of heat or chemical (e.g., initiator or catalyst) means to the precursor.

A polymer “resin,” as used herein, refers to a fluid form of a polymer or a fluid precursor of a polymer that is polymerized to form the polymer.

The “number average” value of a property for a population of individuals is the sum of the value of the property for all individuals in the population divided by the number of individuals in the population.

The “aspect ratio” of a particle is the longest dimension of the particle passing through its center of mass divided by the shortest dimension of the particle passing through its center of mass. For example, the aspect ratio of a sphere is 1 (diameter/diameter), and the aspect ratio of a rod having a circular cross section is the length of the rod divided by the diameter of the rod. Further by way of example, the aspect ratio of a circular plate is the diameter of the plate divided by its thickness.

A “fly ash” is a solid combustion residue that is obtained from the gaseous exhaust of a furnace, incinerator, or other combustion apparatus.

A “nanofiller” is a substance that is solid at the temperature at which a polymer resin is processed and that has a characteristic dimension (e.g., diameter, thickness, or length) not greater than hundreds of nanometers, and preferably not more than tens of nanometers. By way of examples, nanofillers include rod-shaped particles having a diameter of 20 nanometers and substantially square plates having length and breadth of about 75-1500 nanometers each and a thickness of about 1 nanometer.

A “nanoclay” is a nanofiller comprising plate-like mineral particles having a thickness not greater than about 10 nanometers and an aspect ratio in excess of 100.

Detailed Description

The invention relates to a plastic composition that comprises a polymer matrix admixed with a mineralized ash filler (MAF). The plastic can comprise other additives as well, such as one or more of plasticizers, stabilizers, flow modifiers, lubricants, additional fillers, and coloring agents. A preferred additive is a nanofiller, such as a nanoclay. The invention also relates to methods of making such plastics and articles which comprise such plastics. The compositions and methods are described in greater detail below.

The Polymer

The identity of the polymer used as the matrix of the plastic is not critical and will typically be selected based on the intended use of the plastic and the availability and cost of the polymer or its precursors. The plastic can comprise a single polymer or multiple polymers. When multiple polymers are incorporated into the matrix, they can be miscible, immiscible, or partially miscible. By way of example, the plastic can be a (miscible) blend of polybutylene and polypropylene having the MAF uniformly distributed therein. As an alternative example, the plastic can be a bi-phasic polymer such as a styrene-acrylonitrile (SAN) polymer matrix having SAN-coated polybutadiene particles dispersed therein. In this alternative example, the MAF can be suspended in the SAN matrix, in the polybutadiene, or both.

MAF can be advantageously used in polymers which are formed or processed at high temperatures, such as fluoropolymers. It is believed that the relatively low metal content of the MAF decreases temperature-related degradation of the plastic, relative to other fillers.

The individual polymer used to form the polymeric matrix can be a homopolymer or a copolymer (e.g., a block, random, or alternating copolymer). The polymer can be a thermoplastic, a thermoset, or both (i.e., a thermoplastic thermoset).

Examples of suitable thermoplastics include homopolymers and copolymers of polyolefins, polyoxymethylenes, polystyrenes, polyamides, polyimides, polyesters (including polyester terephthalates such as polybutylene terephthalates, polyethylene terephthalates, and polycyclohexane dimethylene terephthalate), fluoropolymers, polyacrylates, polyarylates, polyaryletherketones, polynitriles, polybenzimidazoles, polycarbonates, polyethers, polyphenylene ethers, polyphenylene sulfides, polysulfones, polyaryl sulfones, polyvinyl chlorides, and polyurethanes. Monomers suitable for making thermoplastic monomers are known in the art and include, for example, ethylene, propylene, 1-pentene, 1-butene, 4-methyl-1-pentene, 1-hexene, 1-octene, 1-decane, styrene, acrylonitrile, maleic anhydride, butadiene, ethylidene norbornene, 1,4-hexadiene, 1,5-hexadiene, 1,7-octadiene, 1,9-decadiene, vinyl chloride, and dicyclopentadiene.

Examples of suitable thermoset polymers include diallyl phthalates, amine-formaldehyde polymers, cyanate esters, epoxies, phenolics, unsaturated polyesters, bismaleimides, polyurethanes, silicones, acrylamates, and vinyl esters. Resins suitable for making these thermoset polymers are known in the art.

Selection of one or more polymers for inclusion in the plastic described herein is a routine design decision that will typically be made based on numerous factors, including the cost and availability of polymers or their precursors, the cost and difficulty of manufacturing the plastic, the conditions (e.g., temperature and chemical environment) in which the plastic is to be used, and the required properties (e.g., rigidity, appearance, and durability) of the plastic. Using this information, selection of polymer(s) is a routine engineering choice. The skilled artisan's choice of polymer can be influenced by the differences between the known or expected physical properties of the MAF-filled plastic and the physical properties of either the corresponding neat polymer or the same plastic filled with a different mineral filler. Selection of polymer(s) can also be influenced by differences in the known or expected rheological properties of MAF-containing polymer resins and the rheological properties of neat resins or those containing other mineral fillers.

All of the polymers described herein and their precursors are known in the art and available from commercial sources. Methods of making and processing the polymers described herein and their precursors are also known in the art. Substantially any known starting materials, synthetic methods, and polymer processing equipment can be used to make and form the MAF-containing plastic. Likewise, methods of combining polymer resins with other components are well known, and substantially any of those methods can be used to combine the polymer and the other components of the plastics disclosed herein.

The Mineralized Ash Filler

The invention described herein relates to the discovery that “mineralization” of an ash preparation renders the ash more suitable for use as a plastic filler. Mineralization refers to removal from an ash preparation of metal atoms and compounds that are not part of a relatively inert mineral complex. Plastics that comprise a polymer matrix having mineralized ash dispersed therein exhibit properties superior to those of prior art (non-mineralized) ash-filled plastics (e.g., plastics filled with regular fly ash). Surprisingly, it has also been discovered that mineralized ash fillers increase the melt viscosity far less than do other mineral fillers, such as calcium carbonate.

The metal content of ash depends on the source material from which of the ash is generated, the particular batch of ash, the stream of the incineration process from which the ash is recovered (e.g., fly ash, bottom ash, or coke), and the ash recovery method used. Thus, the metal content of various ashes varies considerably.

Without being bound by any particular theory of operation, it is believed that metal atoms and compounds that can be dissolved or suspended in a polymer resin can affect degradative reactions within the resin or a plastic formed from the resin, for example by initiating or accelerating such reactions. These types of reactions can degrade the polymer or even prevent or inhibit polymerization if the metal concentration is sufficiently high. Reaction of metals with the polymer (or reactions catalyzed by metals) can therefore degrade the properties of the plastic in which the polymer and the metals are incorporated. Reactions between metals and non-polymer additives of the plastic can also degrade the plastic or its properties.

Metal atoms that are present in the form of one or more relatively inert materials (e.g., alumina or silica) do not contribute significantly to degradation of plastic structure or properties. Such mineralized metals can therefore be incorporated into plastics with the expectation that they will act as substantially as inert filler materials.

Use of ordinary fly ash as a plastic filler has been described previously (e.g., Chusid et al., 2003, The Construction Specifier, 36-48). However, ordinary fly ash can have undesirable properties, such as a tendency to stain or discolor the plastic or to reduce the durability or resistance to degradation of the plastic. As described herein, ash preparations can be made more suitable for use as plastic fillers if the metal content of the ash is brought to a low level. This can be achieved in several ways. For example, ash preparations having very low metal content can be selected for use. Alternatively, or in addition, metals can be removed from a metal-containing ash preparation. Many ash products (e.g., coal furnace fly ash) are considered waste products for which few, if any, uses exist, and many of these ash products are simply buried in landfills to dispose of them. Separation of recoverable metals from the relatively inert ash material reduces the amount of material that needs to be disposed of. Furthermore, metals recovered from ash products are valuable resources as well.

Numerous companies presently recover metals from ash waste streams in order to salvage the metals. By way of example, American Ash Recycling Corporation (Jacksonville, Fla.) recovers metals from fly ash obtained from coal-fired power stations. The de-metallized (i.e., mineralized) ash produced as a by-product of metal recovery processes is considered a waste product.

Numerous methods of removing recoverable metals from ash preparations have been described by others. For example, Jakob et al. (1999 paper presented at the 1999 Recovery, Recycling, and Re-integration conference, entitled “Removal of Heavy Metals from Municipal Solid Waste Incinerator Fly Ash: the CT-FLUAPUR Process”) extract metals from ash by subjecting the ash to a high temperature flue gas environment enriched with hydrochloric acid. U.S. Pat. No. 4,130,627 describes an electrolytic process for recovering metals from an ash slurry. Use of carbon dioxide as a metal-extraction agent is described by Chiang et al. (2001, Separat. Sci. Technol. 36(10):2327-2329). Combined use of high-temperature hydrochloric acid treatment and use of the carbon dioxide extraction techniques should provide MAF that is suitable for almost all purposes described herein. If further lowering of metal content is desired (e.g., for applications requiring ultra-low metal ion leaching, such as semiconductor packaging applications), then one or more additional steps can be used, such as contacting the plastic with distilled, de-ionized water for 144 hours. Ion exchange resins can be used to remove metals from ash preparations (see, e.g., McGarvey et al., 1985, “Removal and Recovery of Metals by Ion Exchange” 23rd Annual Liberty Bell Corrosion Course 4, published by Sybron Chemicals, Inc., Birmingham, N.J.). Microbial metal-removing methods are also known (e.g., Krebs et al., 1997, FEMS Microbiol. Rev. 20:605-617; Brombacher et al., 1998, Appl. Environ. Microbiol. 64(4):1237-1241). Any of these or other methods can be used to remove metals from ash preparations. Additional methods of processing ash preparations (e.g., to remove non-combusted carbon, to reduce particle sizes, or both, as shown in U.S. Pat. No. 5,988,396, for example) are also known, and substantially any of these methods can be used to process ash prior to incorporating the ash into a polymer resin.

Another beneficial effect of removing metals from ash prior to incorporating the ash into a plastic is that leaching of metals from the filler is reduced. Many metals that occur in ash preparations have deleterious effects on biological systems. Plastics which contact an organism or a solid or liquid to be consumed by an organism should not leach appreciable amounts of toxic metals. Removal of non-inert metals from ash incorporated into a plastic limits or eliminates metal release from the plastic, rendering it less toxic.

The metal content of the MAF that is considered suitable can depend on the intended use of the plastic that comprises the MAF. For example, when the plastic is to be used in food or beverage storage applications in which direct contact of the food or beverage and the plastic is anticipated, the ash should be substantially free of leachable metals (e.g., not greater than the limits set forth in applicable government regulations for food packaging materials, such as those issued by the Food Safety and Inspection Service of the U.S. Department of Agriculture).

Suitable MAFs can also be characterized based on the content of particular metals. Some metals (e.g., mercury, lead, chromium, and cadmium) are considered to pose greater health hazards than others. Suitable MAFs can be specified which contain less than tolerable levels of one or more of these more hazardous metals. By way of example, suitable MAFs can be made such that their leachates contain not more than 0.01 (0.005, or 0.002) milligram per liter of mercury, not more than 0.2 (0.1, or 0.05) milligram per liter of lead, not more than 0.1 (0.05, or 0.02) milligram per liter of cadmium, and/or not more than 0.5 (0.25, or 0.1) milligram per liter of chromium, each as assessed using ASTM Standard Test Method D3682-01. Examples of other tolerable limits for metals, as assessed using ASTM Standard Test Method D3682-01, include: arsenic, 0.1 (0.05, or 0.02) milligram per liter; barium, 0.5 (0.25 or 0.1) milligram per liter; selenium, 0.1 (0.05, or 0.025) milligram per liter; silver, 0.2 (0.1, or 0.05) milligram per liter; beryllium, 0.1 (0.05, or 0.025) milligram per liter; nickel, 0.2 (0.1, or 0.05) milligram per liter; and/or zinc, 0.2 (0.1, or 0.05) milligram per liter.

The source and form of the ash are not critical for most applications. Because a significant purpose of the MAF is to reduce the amount of polymer resin that must be used to make a plastic, ashes having relatively low density are preferred in many applications. Fly ashes are recovered from gaseous exhaust streams and tend to have relatively low density (e.g., 1-2.2 grams per cubic centimeter). Certain components of fly ashes and other ashes tend to have even lower densities (e.g., 0.5 to 0.8 gram per cubic centimeter for cenospheres). By contrast, calcium carbonate, which is a mineral filler commonly used in plastics, has a density of about 2.7 grams per cubic centimeter. Use of lighter fractions of ash as MAF in plastics can decrease the density of the resulting plastic, relative to use of other fillers such as calcium carbonate. Lightweight plastic formulations are known to be preferable in many applications.

In one embodiment, MAF is made by separating the ash into less dense and more dense fractions. Only the less dense fraction(s) are incorporated into the plastic. The ash can be fractionated prior to mineralization. The ash can also be fractionated after mineralization. Alternatively, density fractionation of the ash can be performed both before and after removal of metals from the ash.

The MAF particles are preferably small in size. Particles having a maximum dimension of not more than about 150 micrometer are suitable, although the MAF preparation can include a small fraction (generally not more than 10, 5, or 2 number %) of larger particles. Preferably, most of the particles have a maximum dimension of not more than about 50 micrometers. Other preferred particles are those which have a maximum dimension of not more than about 20 micrometers and those having a maximum dimension not greater than 3 micrometers. Submicronized particles can also be used, and are preferred in applications in which very high impact resistance and uniformity are desired.

Particulate materials are often sorted by passing them through sieves or other porous media having size-exclusive openings. Suitable MAF materials can be passed through openings equivalent to or greater than those corresponding to an American Standard Sieve Series (ASSS) No. 30 or No. 50 sieve. Preferably, only a very small percentage (e.g., 1-5% of particles are retained by any of ASSS No. 30, No. 50, or No. 100 sieves. Particles that are retained on an ASSS No. 200 sieve are suitable for use as MAF, but smaller particles are also suitable and preferred. There is substantially no lower limit on the size of suitable MAF particles. Mineralized ash particles that are larger than these criteria can be milled, crushed, extruded, or otherwise treated to reduce their size and render them suitable for use in MAF for plastics.

The aspect ratio of MAF particles can affect the properties of plastics into which they are incorporated, particularly when the plastic is in a molten or liquid form. Generally, the rounder the MAF particles are, the lower the viscosity of the polymer resin into which the particles are incorporated will be (at a selected particle concentration). Rounder MAF particles are preferred.

The roundness of MAF particles can be described in multiple ways. The particles can be described in terms of an aspect ratio, comparing long and short dimensions. Preferred MAF particles have an aspect ratio between 1 (i.e., perfect spheres) and 10, more preferably between 1 and 2. Because ash particles are usually present in a variety of sizes and shapes, it is often more practical to use average properties to describe the particles. Thus, MAF preparations wherein the number average aspect ratio is not greater than 2-10 are preferred. The roundness of particles can also be subdivided into two elements—the sphericity of the particles and the absence of sharp comers and edges on the particles. Various systems are known for classifying particles by sphericity and lack of sharp edges. One useful system is that described by Krumbein (1941, J. Sedimentary Petrol. 11(2):64-72). Preferred MAF preparations have particles for which the Krumbein particle sphericity value is not less than about 0.7, the Krumbein particle roundness value is not less than 0.7, or both.

One embodiment of the MAF is an MAF that comprises cenospheres. Cenospheres are substantially spherical particles that occur as a component of various ashes, including fly ashes such as those obtained from coal-fired furnaces operated by power generating stations. Cenospheres can be obtained from numerous commercial sources (e.g., Sphere Services, Inc., Fort Wayne, Ind.; Ashtek Corporation, Portsmouth, N.H.; and Trelleborg Fillite Inc., Norcross, Ga.). Cenospheres can also be separated from ashes using known procedures. Cenospheres can be mineralized using substantially any known process for recovering metals from ash, including those described herein. The cenosphere content of the MAF is not critical. In some embodiments, the MAF substantially does not comprise cenospheres. In preferred embodiments, a substantial portion (e.g., 5%, 10%, 25%, 50%, or 75% or more) of particles of the MAF are cenospheres. Cenospheres that have been substantially isolated from other ash particles can also be used.

The MAF content of the polymer resin is not critical. Generally, increasing MAF content will improve the rheological characteristics (e.g., decreased viscosity and improved processibility) of a polymer resin (relative to the neat resin) until the MAF content exceeds a certain value, which is about 25% by weight for polypropylene. Above that value, the melt viscosity of the resin will generally increase (relative to the neat resin) as the MAF content is further increased. Nonetheless, the melt viscosity of the MAF-filled resin will be lower than that of the resin filled with a non-mineralized ash. The MAF content at which this change is likely to occur will likely be similar for most polymers, and likely not more than 40% nor less than 15% by weight. Thus, Theological properties of polymer resins can be improved by adding up to about 40% MAF, depending on the identity of the polymer(s) in the resin. Typical MAF content values will be in the range 5-40% by weight, preferably 10-30% or 15-25% by weight. The precise amounts corresponding to these property improvements can vary somewhat from polymer to polymer, and can be readily determined experimentally. Nonetheless, the values indicated above approximate the maximum desirable MAF content for most polymers.

The MAF content of a plastic (or polymer resin) affects the physical properties of the finished plastic. MAF enhances the stiffness and rigidity of plastics in which it occurs and reduces the coefficient of thermal expansion (CTE). Owing to the reduced CTE, the plastic swells (and shrinks) less than the corresponding non-filled plastic, and there is greater dimensional stability in molded and thermoformed plastics as a result. Other beneficial effects attributable to incorporation of MAF into a plastic include enhanced fire resistance, surface hardness, and scratch resistance. These benefits generally increase as the MAF content of the plastic increases, until a very high MAF content (e.g., about 60% by weight for polypropylene) is reached, after which plastic properties can decline (e.g., the plastic can become brittle and difficult to shape). MAF can be used to fill plastics in amounts up to that value, which can be routinely determined. The amount of MAF used to fill the plastic can depend on the property which the filler is meant to enhance. For example, if the tensile modulus, stiffness, and surface hardness of the plastic are important characteristics, use of up to about 60% by weight MAF can enhance these properties. If the desired property enhancement is improvement of the plastic's elongation at break, brittleness, or impact resistance, the plastic should generally contain not more than 40-45% by weight MAF. If improvements in the melt viscosity and processibility of the plastic are desired, up to about 25% by weight MAF should be used.

The applicants have discovered that mineralized ash preparations can be used as fillers for plastics and that plastics made using these mineralized ash preparations do not share the drawbacks of (non-mineralized) fly ash-containing plastics.

The MAF is preferably dispersed substantially uniformly in the polymer matrix, but uniform distribution is not critical. As the margin of error for the physical characteristics or dimensions of a plastic part decreases (e.g., for very small or thin plastic parts), it becomes more important that MAF dispersion be uniform within the polymer resin prior to plastic formation.

The MAF need not be chemical derivatized such that it reacts with the polymer matrix or binds to it. It is sufficient if the MAF is simply suspended in the polymer matrix of the plastic. Nonetheless, known methods can be used to chemically derivatize MAF particles to render them susceptible to covalent, ionic, or non-covalent binding with polymer backbones of the polymer resin or plastic. Numerous such methods are known, including surface treatment using organosilane compounds, acrylic-based copolymers, titanates, and zirconates. Internal lubricants and compatibilizers can also be used, if desired.

Other Additives

The MAF described herein can suitably be used as the sole additive to a neat polymer or combination of neat polymers. However, the MAF need not be the only filler added to the polymer resin(s). A wide variety of polymer additives are known in the art for various purposes, and substantially all of them can be used in combination with the MAF. By way of examples, plasticizers, stabilizers, flow modifiers, lubricants, additional fillers, and coloring agents can be used in combination with MAF, and each can be expected to exhibit its normal effect on the resulting polymer resin or plastic.

An advantageous class of polymer additives are those known as nanofillers. Nanofillers are particulate materials having a characteristic dimension not greater than tens of nanometers, such as rod-shaped particles having a diameter of 20 nanometers or substantially square plates having length and breadth of about 75-1500 nanometers each and a thickness of about 1 nanometer. Plate-like nanoclay particles can have very large (e.g., 100, 1000, or higher) aspect ratios. A well known class of nanofillers that is suitable for incorporation into an MAF-containing polymer resin or plastic is the class of compounds called nanoclays. Other common nanofillers that are suitable for use in the plastics described herein include those known in the art as nanotalcs and nanotubes (e.g., carbon nanotubes).

Nanoclays are available from many commercial sources, in a variety of types and sizes. Nanoclays are typically derived from naturally-occurring clays, such as smectites, kaolinites, vermiculites, halloysites, micas, phlogopites, and silicates such as magadiite and kenyaite. Known smectites that have been used as plastic fillers include montmorillonite, saponite, beidellite, nontrite, sauconite, and hectorite. Other stacked-plate type minerals that are useful as nanoclays include illite minerals, aluminum phosphates, and zirconium phosphates. Substantially any of these nanoclays can be incorporated into a MAF-containing plastic described herein. Nanoclays can be incorporated in their naturally-occurring or commercially-available form, or they can first be surface treated to reduce interactions between nanoclay plate particles and improve dispersion of the plates into the polymer matrix. Methods of incorporating nanoclay compositions into polymers have been widely described, and substantially any known method of incorporating them into plastics described herein can be used, such as the methods described in U.S. Pat. No. 6,465,543 or that described in U.S. Pat. No. 6,518,324. Surface treatments for rendering nanoclays more suitable for incorporation into polymer matrices are also known and can be used to make plastics that contain MAF and the treated nanoclay. Nanoclays are available from commercial sources, such as Nanocor, Inc. (Arlington Heights, Ill.) which sells nanoclay concentrates (e.g., 50% nanoclay by weight) suspended in polyethylenes, polypropylenes, and thermoplastic polyolefins.

The amount of nanofiller incorporated into the polymer matrix is not critical. Like other relatively inert fillers (other than MAF, as described herein), nanofillers tend to be detrimental to the rheological properties of polymer resins (e.g., molten or softened thermoplastics or non-crosslinked thermosets) when they are incorporated therein. Polymer resins having nanofillers suspended therein tend to have higher viscosity, higher abrasiveness, and lower processibility than the corresponding neat polymer resins. Nanofillers are preferably not present in the polymer resins described herein at more than about 10% by dry weight. Preferable resins comprise about 1-7%, by weight nanofiller, more preferably about 5-7%.

In addition to the ordinary physical property enhancements that inert mineral fillers tend to impart to a finished plastic (i.e., improved stiffness, rigidity, thermal expansion, fire resistance, surface hardness, and scratch resistance), the plate-like structure of nanoclays also improves the permeation resistance of a plastic to gases and liquids and the sag resistance of the plastic.

Plastic Production

In its isolated form, the MAF described herein is a powdery substance. Like other powders, MAF can be incorporated into a molten polymer matrix or into a liquid or powdered thermoset material using standard polymer processing technology and equipment.

By way of example, pellets of a thermoplastic polymer and MAF (e.g., compressed MAF pellets, free-flowing MAF, or MAF suspended at a relatively high concentration in the same or a different thermoplastic polymer) can be fed into the intake of a single- or twin-screw extruder. The extruder combines and mixes the polymer, the MAF, and any other desired additives to form a molten polymer mass that can be further processed into a desired plastic shape.

Thermoplastic processing need not be performed using a screw-driven extruder, but can instead be performed with any known polymer processing equipment or method. A non-limiting list of suitable thermoplastic processing methods by which an MAF-filled thermoplastic can be formed, shaped, or both, includes extrusion, pultrusion, traditional injection molding, injection compression molding (i.e., coining), hollow injection molding, foam injection molding, sandwich molding, compression molding, thermoforming, conventional blow molding, injection blow molding, twin sheet forming, stamping, twin sheet stamping, filament coating and winding, and rotational casting.

Further by way of example, MAF can be incorporated into a thermoset resin prior to, or during, polymerization or polycondensation of the resin, so that the MAF is included in the finished plastic article. The MAF can be incorporated into the resin by agitation, mixing by flow through a static mixing device, turbulent flow, ball or roller mill, or otherwise. A non-limiting list of suitable thermoset processing methods by which an MAF-filled thermoset plastic can be formed, shaped, or both, includes compression molding, traditional injection molding, reaction injection molding, resin transfer molding, cold press molding, high-speed resin injection, pultrusion, and winding of resin-impregnated filament.

Another example of a suitable use of MAF as a polymer filler is incorporation of MAF into a paint or other coating composition. The MAF can be suspended in the composition and incorporated in the coating as it dries or sets.

Following production of an MAF-containing plastic, the plastic can be further processed using standard fabrication techniques such as cutting, machining, drilling, gluing, welding, fusing, compressing, shredding, pelleting, coating, painting, laminating, and the like. MAF-containing thermoplastics can be further processed by known thermoplastic shaping and forming techniques such as thermoforming or pelletizing followed by injection molding of the pelletized plastic.

Choices of suitable plastic production and processing techniques are merely routine design choices based, for example, on the size, nature, and required physical properties of a desired plastic or plastic-containing article. A skilled artisan is able to select among known techniques once a desired article, its use, and its properties are specified.

The MAF-containing plastics described herein can be incorporated into substantially any plastic or plastic-containing article. Examples of common plastic articles include pellets, flakes, planks, panels, sheets, films, rods, tubes, spheres, multi-layer structures, and irregular shapes. Plastics are also commonly molded, machined, or both, to form a part having a desired shape, so that the part can be assembled together with other plastic or non-plastic parts to form a finished article or a sub-assembly of a larger article.

In one embodiment, an MAF-containing plastic described herein is used to form an article that consists essentially of the plastic. By way of example, many plastics can be used to form building materials, such as roofing, siding, piping, railing, fencing, decking, flooring, framing, and trimming materials. The building materials can be load-bearing members, such as planks intended for use in residential decking applications, or non-load-bearing, such as ornamental features (e.g., cornices, trims, and moldings).

In another embodiment, an MAF-containing plastic described herein is integrated with another material to form an article. The plastic can, for example, be used to coat or fill the other material, or the other material can be shredded and mixed with the plastic. By way of example, an MAF-containing plastic can be used to coat a wood plank or to fill a void in an article (e.g., a plastic tube) formed from a plastic that does not comprise MAF. Further by way of example, layers of the MAF-containing plastic can be alternated with layers of another material (e.g., wood sheets, cotton fabric sheets, metal plates, foamed polymer blocks, or fiberglass mats) to form a layered composite structure. Particulate or fibrous materials (e.g., wood chips, saw dust, wood flour, shredded fiberglass, cotton fibers, or polymer fibers) can also be mixed with the MAF-containing plastic, either in an oriented fashion (e.g., substantially aligned or parallel fibers) or in a random fashion. Thus, MAF-containing plastics can be incorporated into materials such as plywoods, pressboards, and particleboards.

MAF-containing plastics can comprise metal materials, such as flakes, filings, sheets, bars, wires, blocks, or woven mats of iron, steel, copper, or aluminum. Metal and other conducting materials can be incorporated within MAF-containing plastics to form, for example, partially encapsulated circuits, heating elements, antennas, insulated conductors, and the like.

### EXAMPLES

The invention is now described with reference to the following Examples. These Examples are provided for the purpose of illustration only, and the invention is not limited to these Examples, but rather encompasses all variations which are evident as a result of the teaching provided herein.

### Example 1

Analysis of Commercially Obtained Mineralized Fly Ash

Elemental analysis of fly ash and two different metal recovery ash waste samples was performed by two commercial laboratories according to the testing method set forth in EPA method 200.7 (all metals except mercury; EPA Report #600/4-79-020) and by EPA method 245.1 (for mercury; EPA Report #600/4-79-020). The EPA methods are described in Methods for the Determination of Metals in Environmental Samples—Supplement I (EPA-600/R-94- 111, May 1994; NTIS publication PB 94-184942). Sample preparations methods used are described in EPA document SW-846 (“Test Methods for Evaluating Solid Wastes”). Using a toxicity characteristic leaching procedure (TCLP) extraction apparatus, 100 grams of the mineralized fly ash sample was combined with 2 liters of synthetic precipitate leaching procedure Extraction Fluid #1 (i.e., a 20:1 liquid-to-solid ratio) and extracted for 18 hours. The mixture was then filtered, and the TCLP filtrate was analyzed using inductively coupled plasma and/or synthetic precipitation leaching procedures (EPA method 1312 in document SW-846). Elemental analysis results for selected metals are listed in Table 1.

TABLE 1

Commercial Mineralized Fly Ash

| | Standard Fly Ash | Results, Test 1 | Results, Test 2 |
|---|---|---|---|
| Element | TCLP filtrate concentration, milligrams per liter | | |
| As | 0.1 | <0.100 | <0.010 |
| Ba | 20.00 | 0.3 | 0.094 |
| Cd | 0.500 | <0.020 | 0.011 |
| Cr | 4.00 | 0.280 | 0.016 |
| Pb | 2.00 | <0.040 | 0.074 |
| Hg | 0.10 | <0.002 | <0.0002 |
| Se | 0.60 | <0.100 | 0.028 |
| Ag | 2.00 | <0.040 | — |
| Ni | 0.50 | — | 0.050 |
| Zn | 0.50 | — | 0.045 |

Table 2 lists illustrates the size distribution of particles in a commercially-obtained mineralized fly ash preparation, as assessed at an ash moisture content of 8.63% by weight.

TABLE 2

| | Corresponding | Weight % of Particles |
|---|---|---|
| American Standard Sieve | Size | Retained on Sieve |
| Series Designation | (micrometers) | Screen |
| ½ inch | | 0.00 |
| ⅜ inch | | 0.00 |
| No. 4 | | 0.00 |
| No. 8 | | 0.00 |
| No. 16 | | 0.00 |
| No. 30 | >600 | 0.79 |
| No. 50 | >300 | 0.79 |
| No. 100 | >150 | 2.35 |
| No. 200 | >75 | 22.05 |
| >No. 200 | <75 | 74.02 |
| | Total: | 100.00 |

### Example 2

Manufacture of Plastics

Plastic formulations comprising no filler, calcium carbonate (“CC”) as a filler, mineralized fly ash (“MFA”) as a filler, nanoclay filler, or some combination of these were made in order to investigate their rheological and mechanical properties. The compositions of the formulations made are listed in Table 3.

TABLE 3

| | | Fillers (% by weight) | | |
|---|---|---|---|---|
| Polymer Designation | Polymer Matrix | CC | MFA | Nanoclay |
| A | PP-A | 0 | 0 | 0 |
| B | PP-B | 0 | 0 | 0 |
| C | PP-A | 20 | 0 | 0 |
| D | PP-A | 40 | 0 | 0 |
| E | PP-A | 60 | 0 | 0 |
| F | PP-A | 80 | 0 | 0 |
| G | PP-B | 20 | 0 | 0 |
| H | PP-B | 40 | 0 | 0 |
| I | PP-B | 60 | 0 | 0 |
| J | PP-A | 0 | 20 | 0 |
| K | PP-A | 0 | 25 | 0 |
| L | PP-A | 0 | 30 | 0 |
| M | PP-A | 0 | 40 | 0 |
| N | PP-A | 0 | 60 | 0 |
| O | PP-A | 40 | 0 | 7 |
| P | PP-A | 40* | 0 | 7 |
| Q | PP-A | 0 | 40 | 7 |

*Note: Calcium carbonate in this sample was hydrophobicized by modification with calcium stearates or other stearate salts.

All of the plastic formulations were made using polypropylene as the polymer matrix. Polypropylene resins were obtained from Huntsman Corporation (Salt Lake City, Utah). The resins used were polypropylene homopolymer (propylene homopolymer PP 41E4cs215 (film extrusion grade), obtained from Rexene Corporation, Parsippany, N.J., having a melt flow rate of 4 grams/10 minutes; designated “PP-A” in Table 3) and polypropylene co-polymer (random propylene copolymer PP 13T 12A (injection molding grade), obtained from Rexene Corporation, having a melt flow rate of 12 grams/10 minutes; designated “PP-B” in Table 3). The resins were obtained in the form of pellets having approximate dimensions of 2.5-3 millimeters in length and 1.5-2 millimeters in diameter. All of the formulations were thermally stabilized using 0.25% by weight of the hindered phenolic anti-oxidant stabilizer designated IRGANOX™ 1076 (Ciba Specialty Chemicals, Tarrytown, N.Y.).

Calcium carbonate was obtained from Specialty Minerals, Inc. (Bethlehem, Penn.; SUPER-PFLEX™ 100 grade). This material had a moisture content of less than 0.5%, a mean particle size of about 0.6-0.9 micrometers, and a specific gravity of about 2.71 grams per cubic centimeter.

The mineralized fly ash (“MFA”) used in the plastic formulations was obtained from American Ash Recycling Corporation (Jacksonville, Fla.). Elemental analyses of MFA performed by two commercial laboratories are described in Example 1.

The nanoclay concentrate was obtained from Nanocor, Inc. (Arlington Heights, Ill.) as the product designated NANOMER® P-801. The nanoclay used in the compositions listed in Table 3 was incorporated into the polypropylene matrix in the form of a concentrate of the nanoclay suspended in polypropylene at a known concentration of about 50% by weight.

The dry components of the formulations were mixed, followed by melt compounding in a twin-screw extruder (WERNER & PFLEIDER™ model ZSK-30, obtained from Coperion Corporation, Ramsey, N.J.) and pelletization using a rotational knife drum. The melt compounding temperatures of the barrel of the extruder were in the range of from 165° C. in the feeding section, gradually rising to 235° C. in the die plate. Fabricated plastic strands were cooled in a water bath followed by water drying and pelletization of the strands into pellets 3-4 millimeters in length and 2.5-3.0 millimeters in diameter. The pellets of all materials were used to measure the flow curves at various temperatures, e.g., 190° C., 210° C., and 230° C. as typical PP processing temperatures. The injection-molded specimens of standard size were also fabricated for evaluation of mechanical properties.

Rheological measurements were made using a capillary rheometer sold by Goettfert (Rock Hill, S.C.) under the trade name RHEOGRAPH™ 1000. Melt flow curves (i.e., plots of apparent viscosity against apparent shear rate) were measured at 190, 210, and 230 degrees Celsius. These temperatures represent typical polypropylene processing temperatures. Samples of the polypropylene formulations listed in Table 3 were tested.

Results

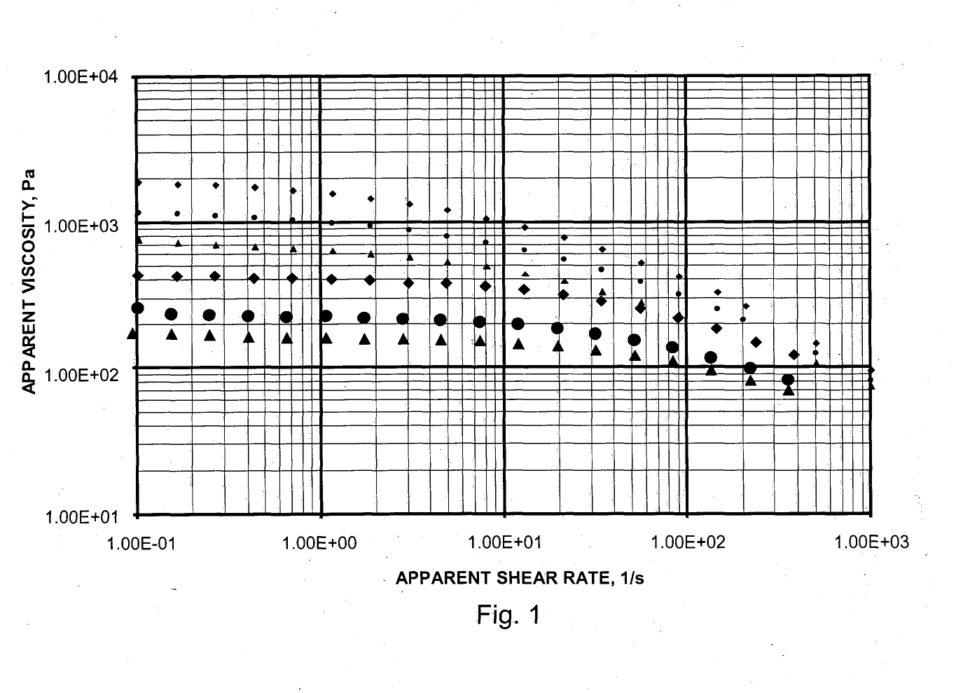

The apparent viscosity of the neat polypropylene homopolymer formulation (A in Table 3) was significantly higher than the apparent viscosity of the neat polypropylene copolymer formulation (B in Table 3) at the same apparent shear rate for all temperatures studied, as shown in the melt flow curves in FIG. 1.

Comparison of the melt flow curves at 190, 210, and 230 degrees Celsius for formulations C, D, and E in Table 3 polypropylene homopolymer comprising 20, 40, and 60% by weight calcium carbonate, respectively) indicated that the viscosity of the polymer resin increased as the amount of mineral filler therein increased at each processing temperature, as was previously known.

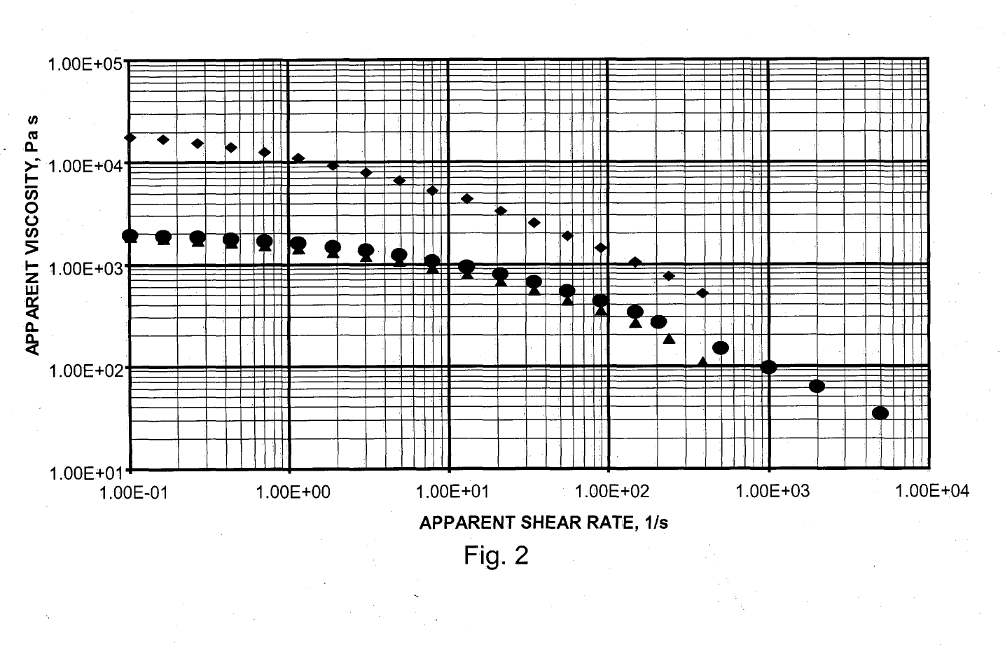

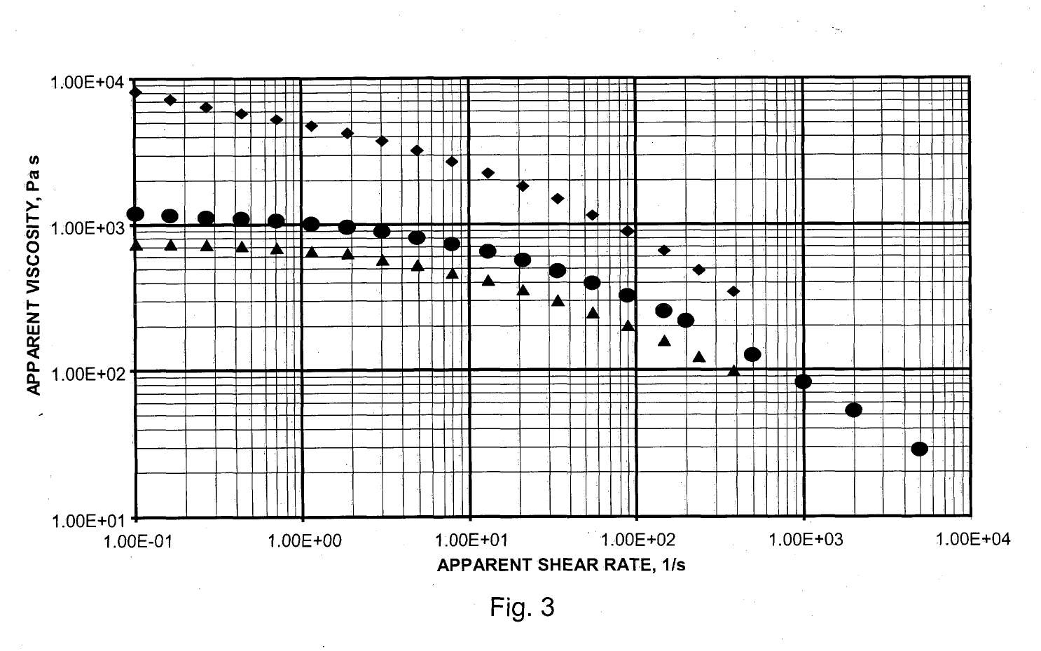

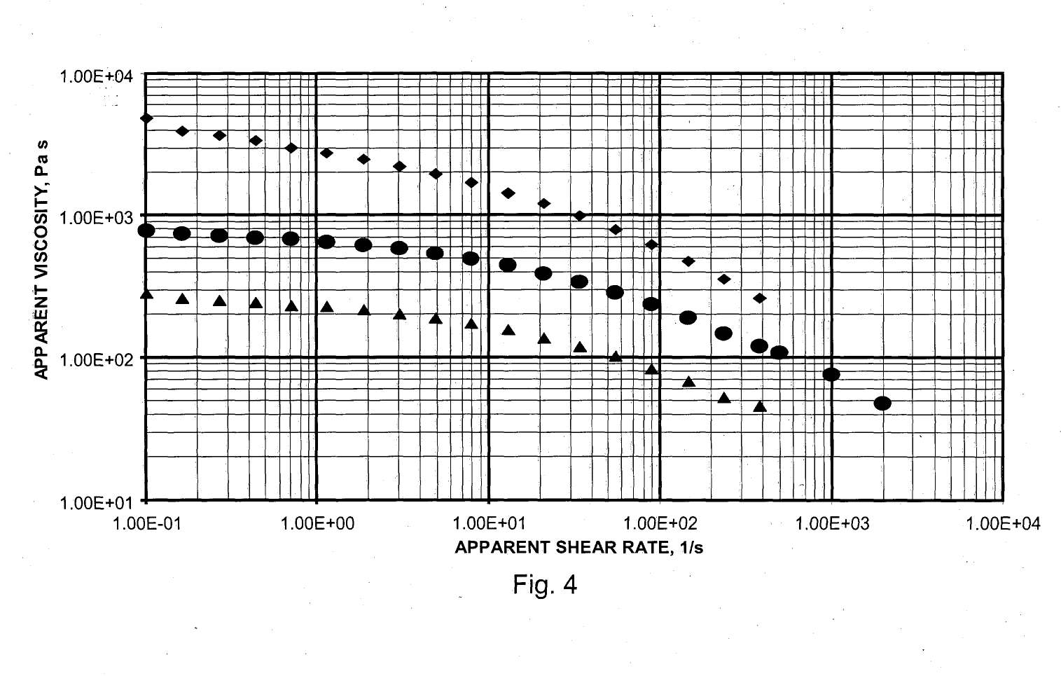

Comparison of the melt flow curves at 190, 210, and 230 degrees Celsius for formulations A, J, and M (polypropylene homopolymer comprising 0, 20, and 40% by weight MFA, respectively; FIGS. 2, 3, and 4) indicated three things. First, at each temperature, the apparent viscosity of the formulation comprising 20% MFA was lower than the apparent viscosity of the neat homopolymer at all apparent shear rates. Second, the difference between the apparent viscosity of the formulation comprising 20% MFA and the apparent viscosity of the neat formulation increased with increasing temperature. Third, the decrease in apparent viscosity with increasing apparent shear rate was more pronounced for each of the two MFA-containing formulations than for the neat homopolymer. These observations indicate that MFA unexpectedly reduces the viscosity of a polymer melt (i.e., increase its flowability) and thereby improves its processibility. This effect is observed in polypropylene at MFA concentrations up to about 25% by weight, above which concentration increasing the MFA content causes an increase in the polymer melt viscosity. Similar boundaries for the beneficial effects of MFA addition on the rheological properties of polymer melts can be determined for other polymers using similar experiments.

Comparison of the melt flow curves at 190, 210, and 230 degrees Celsius for formulation O (polypropylene homopolymer comprising 40% by weight calcium carbonate and 7% by weight of nanoclay) indicated that the effect of the nanoclay at a concentration of 7% on the rheological characteristics of the formulations dominated the temperature effects on those properties.

Comparison of the melt flow curves at 190, 210, and 230 degrees Celsius for formulations O, P, and Q (polypropylene homopolymer comprising 40% by weight calcium carbonate, modified calcium carbonate, and MFA, respectively and also comprising 7% by weight of nanoclay) indicated that the effect of the nanoclay at a concentration of 7% on the rheological characteristics of the formulations dominated the effects of the other fillers on those properties when those other fillers were present at a concentration of 40%.

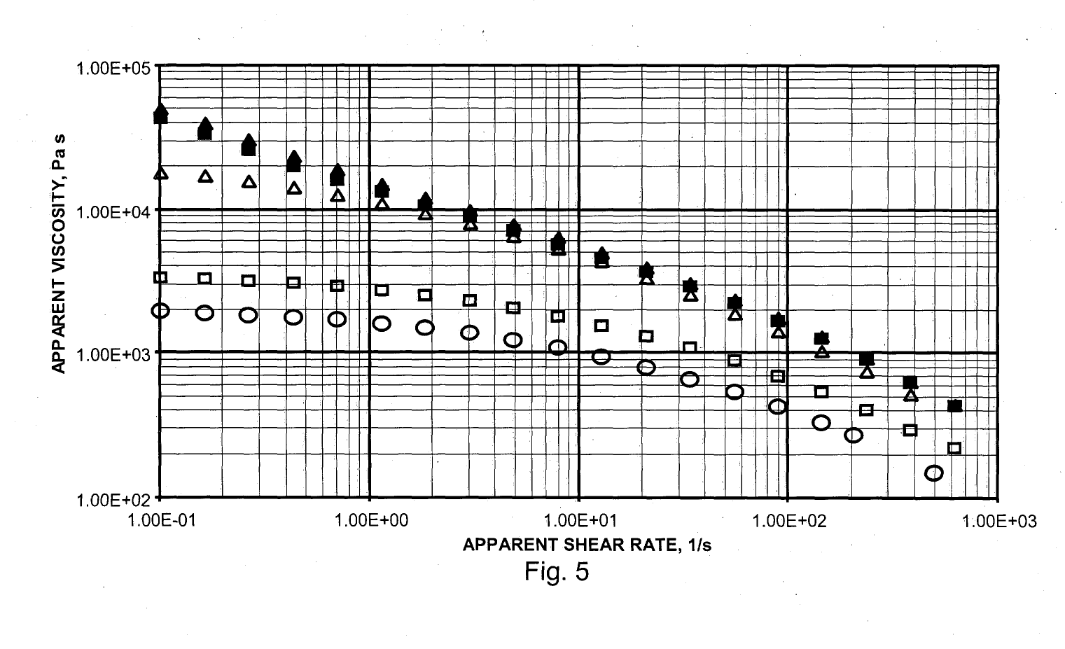

The melt flow curves shown in FIGS. 5 (190 degrees Celsius) and 6 (210 degrees Celsius) demonstrate that the viscosity-lowering effect of addition of MFA to a polymer increases with increasing melt processing temperature. This result suggests that addition of MFA can be particularly beneficial for lowering the viscosity and enhancing the processibility of polymers (e.g., fluoropolymers) that are formed or processed at relatively high temperatures.

When the tensile modulus of formulation J was compared with the modulus of formulations C, D, and E, it was found that adding 20% by weight of MFA to the polymer formulation increased the tensile modulus approximately as much as adding 60% calcium carbonate. Addition of nanoclay to the polymer formulation also increased its tensile modulus.

Taken together, the results presented in this example demonstrate that addition of MFA to a polypropylene composition can enhance the viscosity (i.e., by lowering it) and processibility of the compositions and also increase the tensile modulus of plastic formed from that composition. The results also indicate that addition of a nanoclay can increase the tensile modulus of polypropylene when it is incorporated into the polymer, in addition to the other known beneficial effects of nanoclays on polymer formulations.

The disclosure of every patent, patent application, and publication cited herein is hereby incorporated herein by reference in its entirety.

While this invention has been disclosed with reference to specific embodiments, it is apparent that other embodiments and variations of this invention can be devised by others skilled in the art without departing from the true spirit and scope of the invention. The appended claims include all such embodiments and equivalent variations.

1. A plastic comprising a polymer admixed with a mineralized ash filler.

2. The plastic of claim 1, wherein the polymer is a thermoplastic.

3. The plastic of claim 2, wherein the polymer is substantially a homopolymer selected from the group consisting of polyolefins, polyoxymethylenes, polystyrenes, polyamides, polyimides, polyesters, fluoropolymers, polyacrylates, polyarylates, polyaryletherketones, polynitriles, polybenzimidazoles, polycarbonates, polyethers, polyphenylene ethers, polyphenylene sulfides, polysulfones, polyaryl sulfones, polyvinyl chlorides, and polyurethanes.

4. The plastic of claim 2, wherein the polymer is a copolymer of at least two polymers selected from the group consisting of polyolefins, polyoxymethylenes, polystyrenes, polyamides, polyimides, polyesters, fluoropolymers, polyacrylates, polyarylates, polyaryletherketones, polynitriles, polybenzimidazoles, polycarbonates, polyethers, polyphenylene ethers, polyphenylene sulfides, polysulfones, polyaryl sulfones, polyvinyl chlorides, and polyurethanes.

5. The plastic of claim 2, wherein the polymer is a polymer of at least one monomer selected from the group consisting of ethylene, propylene, 1-pentene, 1-butene, 4-methyl-1-pentene, 1-hexene, 1-octene, 1-decane, styrene, acrylonitrile, maleic anhydride, butadiene, ethylidene norbornene, 1,4-hexadiene, 1,5-hexadiene, 1,7-octadiene, 1,9-decadiene, vinyl chloride, and dicyclopentadiene.

6. The plastic of claim 2, wherein the polymer is a blend of at least two polymers selected from the group consisting of polyolefins, polyoxymethylenes, polystyrenes, polyamides, polyimides, polyesters, fluoropolymers, polyacrylates, polyarylates, polyaryletherketones, polynitriles, polybenzimidazoles, polycarbonates, polyethers, polyphenylene ethers, polyphenylene sulfides, polysulfones, polyaryl sulfones, polyvinyl chlorides, and polyurethanes.

7. The plastic of claim 6, wherein the polymers are miscible.

8. The plastic of claim 6, wherein the polymers are immiscibly blended.

9. The plastic of claim 1, wherein the polymer is a thermoset.

10. The plastic of claim 9, wherein the polymer is selected from the group consisting of diallyl phthalates, amine-formaldehyde polymers, cyanate esters, epoxies, phenolics, unsaturated polyesters, bismaleimides, polyurethanes, silicones, acrylamates, and vinyl esters.

11. The plastic of claim 1, comprising not more than about 60% by weight mineralized ash filler.

12. The plastic of claim 1, comprising not more than about 40% by weight mineralized ash filler.

13. The plastic of claim 1, comprising not more than about 25% by weight mineralized ash filler.

14-15. (Canceled)

16. The plastic of claim 1, wherein the composition comprises the mineralized ash filler in an amount sufficient to lower the viscosity of the composition at a temperature in the range 170 to 270 degrees Celsius, relative to the viscosity of the polymer alone at the same temperature and shear rate.

17. The plastic of claim 1, wherein the mineralized ash filler comprises a mineralized fly ash.

18. The plastic of claim 17, wherein the mineralized fly ash is obtained from a coal-burning furnace.

19. The plastic of claim 17, wherein the leachable metal content of the mineralized fly ash is not greater than about 10 milligrams per milliliter, as assessed using ASTM Standard Test Method D3682-01.

20. The plastic of claim 17, wherein the leachable metal content of the mineralized fly ash is not greater than about 5 milligrams per milliliter, as assessed using ASTM Standard Test Method D3682-01.

21. The plastic of claim 17, wherein the leachable metal content of the mineralized fly ash is not greater than about 2 milligrams per milliliter, as assessed using ASTM Standard Test Method D3682-01.

22. The plastic of claim 17, wherein the leachable metal content of the mineralized fly ash is not greater than about 1 milligram per milliliter, as assessed using ASTM Standard Test Method D3682-01.

23. The plastic of claim 17, wherein i) the leachable lead content of the mineralized fly ash is not greater than about 0.2 milligram per milliliter; ii) the leachable chromium content of the mineralized fly ash is not greater than about 0.5 milligram per milliliter; and iii) the leachable cadmium content of the mineralized fly ash is not greater than about 0.1 milligram per milliliter, as assessed using ASTM Standard Test Method D3682-01.

24. The plastic of claim 17, wherein not more than about 1% by weight of the ash particles are retained on an American Standard Sieve Series (ASSS) No. 30 sieve.

25. The plastic of claim 17, wherein not more than about 1% by weight of the ash particles are retained on an ASSS No. 50 sieve.

26. The plastic of claim 17, wherein not more than about 5% by weight of the ash particles are retained on an ASSS No. 100 sieve.

27. The plastic of claim 17, wherein not more than about 25% by weight of the ash particles are retained on an ASSS No. 200 sieve.

28-32. (Canceled)

33. The plastic of claim 1, further comprising a second filler.

34. The plastic of claim 33, wherein the second filler is a nanofiller.

35. (Canceled)

36. The plastic of claim 34, wherein the nanofiller is a nanoclay.

37-40. (Canceled)

41. The plastic of claim 36, wherein the nanoclay is montmorillonite that has been surface-treated to decrease association of nanoclay particles with one another.

42. The plastic of claim 36, comprising not more than about 7% by dry weight of the nanoclay.

43. The plastic of claim 36, wherein the number average maximum dimension of the nanoclay particles is not greater than about 500 nanometers.

44-47. (Canceled)

48. A manufactured article comprising the plastic of claim 1.

49. The article of claim 48, formed into a building material.

50. The article of claim 49, wherein the building material is selected from the group consisting of roofing, siding, insulation, piping, railing, fencing, decking, flooring, framing, and trimming materials.

51. The article of claim 49, wherein the building material is a plank.

52. The article of claim 49, wherein the building material is an ornamental building material.

53. The article of claim 49, wherein the building material is a structural building material.

54-58. (Canceled)

59. A method of making a plastic, the method comprising incorporating a mineralized ash filler into a polymer resin and thereafter solidifying the resin to form the plastic.

60-65. (Canceled)

66. The method of claims 59, wherein the polymer is formed into a shape selected from the group consisting of a plank, a sheet, a tube, and a pellet prior to solidifying the resin.

67-123. (Canceled)

124. A method of increasing the tensile modulus of a plastic, the method comprising incorporating up to about 60% by weight of a mineralized ash filler into the plastic.

125-130. (Canceled)
